(19) United States
(12) Patent Application Publication
(10) Pub. No.: US 2024/0280717 A1
(43) Pub. Date: Aug. 22, 2024

(54) EFFICIENT NONLINEAR BEAMFORMING VIA ON-THE-FLY MODEL-SPACE RECONSTRUCTION

(71) Applicant: SAUDI ARABIAN OIL COMPANY, Dhahran (SA)

(72) Inventors: Yimin Sun, Den Haag (NL); Quentin Hirsch, Delft (NL)

(73) Assignee: Aramco Overseas Company B.V., The Hague (NL)

(21) Appl. No.: 18/162,547

(22) Filed: Jan. 31, 2023

(51) Int. Cl. G01V 1/30; E21B 44/00

(52) U.S. Cl. CPC G01V 1/301; E21B 44/00; G01V 1/305

(57) ABSTRACT

A method is disclosed that includes obtaining a seismic data set from a seismic survey conducted over a subterranean region of interest and discretizing the seismic data set into a plurality of sub-regions each with a local traveltime operator. The method further includes dividing the plurality of sub-regions into a first subset and a second subset and calculating the local traveltime operator for each sub-region of the first subset using a conventional method and determining the local traveltime operator for each sub-region of the second subset using a convergent POCS method based on the local traveltime operators for the sub-regions of the first subset. The method further includes determining an enhanced seismic dataset by performing non-linear beamforming using the local traveltime operator for each sub-region of the plurality of sub-regions and determining a location of a hydrocarbon reservoir in the subterranean region of interest using the enhanced seismic data set.

### BACKGROUND

Seismic surveys are frequently conducted by participants in the oil and gas industry. Seismic surveys are conducted over subterranean regions of interest during the search for, and characterization of, hydrocarbon reservoirs. In seismic surveys, a seismic source generates seismic waves that propagate through the subterranean region of interest and are detected by seismic receivers. The seismic receivers detect and store a time-series of samples of earth motion caused by the seismic waves. The collection of time-series samples recorded at many seismic receiver locations generated by a seismic source at many source locations constitutes a seismic data set.

Once acquired, a seismic data set may undergo a myriad of processing steps. The purposes of these processing steps include, but are not limited to, reducing signal noise, identifying subterranean structures and surfaces, and data visualization.

One such processing technique is non-linear beamforming (NLBF) which comprises the summation of time-shifted seismic data across multiple seismic receivers. The time-shift is determined by a so-called move-out function. The move-out function is parameterized by a set of parameters that must be determined before employing a NLBF procedure. Generally, a seismic data set is partitioned into various spatial and temporal sub-regions and an independent move-out function is used in each sub-region. It is not uncommon for single seismic data set to have millions, if not billions, of sub-regions, each with an associated move-out function. To apply a NLBF procedure to a seismic data set, the parameters of each move-out function must be determined.

Generally, the move-out function parameters for a single spatial and temporal sub-region of the seismic data set are determined by optimizing an objective function. The objective function may be a semblance-like function where greater values of this objective function correspond to increased coherence among the time-series data collected over multiple seismic receivers. The optimization of the objective function is typically performed by an iterative non-linear optimizer and may be considered a computationally slow and computationally expensive process. The computational cost of determining the move-out function parameters for a seismic data set is multiplied according to the number of sub-regions used in the seismic data set. Consequently, the use of the NLBF procedure, or its resolution, may be limited.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method that includes obtaining a seismic data set from a seismic survey conducted over a subterranean region of interest and discretizing the seismic data set into a plurality of sub-regions each with a local traveltime operator. The method further includes dividing the plurality of sub-regions into a first subset and a second subset and calculating the local traveltime operator for each sub-region of the first subset using a conventional method and determining the local traveltime operator for each sub-region of the second subset using a convergent POCS method based on the local traveltime operators for the sub-regions of the first subset. The method further includes determining an enhanced seismic dataset by performing non-linear beamforming using the local traveltime operator for each sub-region of the plurality of sub-regions and determining a location of a hydrocarbon reservoir in the subterranean region of interest using the enhanced seismic data set.

Embodiments disclosed herein generally relate to a non-transitory computer-readable memory including computer-executable instructions stored thereon that, when executed on a processor, cause the processor to obtain a seismic data set from a seismic survey conducted over a subterranean region of interest and discretize the seismic data set into a plurality of sub-regions each with a local traveltime operator. The non-transitory computer-readable memory further includes instructions that cause the processor to divide the plurality of sub-regions into a first subset and a second subset and calculate the local traveltime operator for each sub-region of the first subset using a conventional method. The non-transitory computer-readable memory further includes instructions that cause the processor to determine the local traveltime operator for each sub-region of the second subset using a convergent POCS method based, at least in part, on the local traveltime operators for the sub-regions of the first subset. The non-transitory computer-readable memory further includes instructions that cause the processor to determine an enhanced seismic dataset by performing non-linear beamforming using the local traveltime operator for each sub-region of the plurality of sub-regions.

Other aspects and advantages of the claimed subject matter will be apparent from the following description and the appended claims.

### BRIEF DESCRIPTION OF DRAWINGS

FIG. 1 depicts a seismic survey in accordance with one or more embodiments.

FIG. 2 depicts an abstract seismic data set in accordance with one or more embodiments.

FIG. 3 depicts a drilling operation in accordance with one or more embodiments.

FIG. 4 depicts a flowchart in accordance with one or more embodiments.

FIG. 5 depicts a flowchart in accordance with one or more embodiments.

FIG. 6 depicts a method for generating a parameter data set for each parameter of a move-out function, in accordance with one or more embodiments.

FIG. 7 depicts a parameter data set in accordance with one or more embodiments.

FIG. 8 depicts a flowchart in accordance with one or more embodiments.

FIG. 9 depicts various instances of alternating projections of parameter data sets between convex sets, in accordance with one or more embodiments.

FIG. 10A depicts select iterations of alternating projections between convex sets in accordance with one or more embodiments.

FIG. 10B depicts a convergence history in accordance with one or more embodiments.

FIG. 11A depicts an example parameter data set before application of a CP method, in accordance with one or more embodiments.

FIG. 11B depicts an example parameter data set during application of a CP method, in accordance with one or more embodiments.

FIG. 11C depicts an example parameter data set after application of a CP method, in accordance with one or more embodiments.

FIG. 12A depicts an example parameter data set before projection onto a convex set in accordance with one or more embodiments.

FIG. 12B depicts an example parameter data set after projection onto a convex set in accordance with one or more embodiments.

FIG. 12C depicts an example parameter data set after projection onto another convex set in accordance with one or more embodiments.

FIG. 13A depicts an example seismic data set in accordance with one or more embodiments.

FIG. 13B depicts an example enhanced seismic data set in accordance with one or more embodiments.

FIG. 14 depicts a flowchart in accordance with one or more embodiments.

FIG. 15 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “acoustic signal” includes reference to one or more of such acoustic signals.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

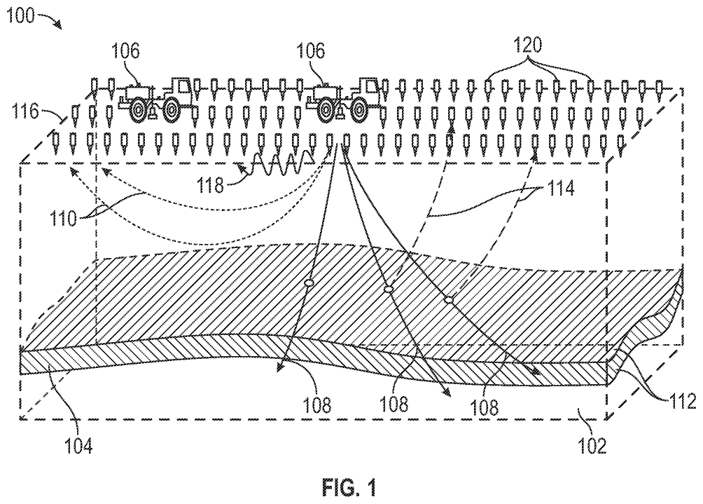

In the following description of FIGS. 1-15, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

FIG. 1 shows a seismic survey (100) of a subterranean region of interest (102), which may contain a hydrocarbon reservoir (104). In some cases, the subterranean region of interest (102) may lie beneath a lake, sea, or ocean. In other cases, the subterranean region of interest (102) may lie beneath an area of dry land. The seismic survey (100) may utilize a seismic source (106) that generates radiated seismic waves (108). The type of seismic source (106) may depend on the environment in which it is used, for example on land the seismic source (106) may be a vibroseis truck or an explosive charge, but in water the seismic source (106) may be an airgun. The radiated seismic waves (108) may return to the surface of the earth (116) as refracted seismic waves (110) or may be reflected by geological discontinuities (112) and return to the surface as reflected seismic waves (114). The radiated seismic waves may propagate along the surface as Rayleigh waves or Love waves, collectively known as “ground-roll” (118). Vibrations associated with ground-roll (118) do not penetrate far beneath the surface of the earth (116) and hence are not influenced, nor contain information about, portions of the subterranean region of interest (102) where hydrocarbon reservoirs (104) are typically located. Seismic receivers (120) located on or near the surface of the earth (116) detect reflected seismic waves (114), refracted seismic waves (110) and ground-roll (118).

In accordance with one or more embodiments, the refracted seismic waves (110), reflected seismic waves (114), and ground-roll (118) generated by a single activation of the seismic source (106) are recorded by a seismic receiver (120) as a time-series representing the amplitude of ground-motion at a sequence of discrete sample times. Usually the origin of the time-series, denoted t=0, is determined by the activation time of the seismic source (106). This time-series may be denoted a seismic “trace”. The seismic receivers (120) are positioned at a plurality of seismic receiver locations which we may denote (xᵣ,yᵣ) where x and y represent orthogonal axes on the surface of the earth (116) above the subterranean region of interest (102). Thus, the plurality of seismic traces generated by activations of the seismic source (106) at a single location may be represented as a three-dimensional “3D” volume with axes (xᵣ,yᵣ,t) where (xᵣ,yᵣ) represents the location of the seismic receiver (120) and t denotes the time sample at which the amplitude of ground-motion was measured. The collection of seismic traces is herein referred to as the seismic data set.

However, a seismic survey (100) may include recordings of seismic waves generated by a seismic source (106) sequentially activated at a plurality of seismic source locations denoted (xₛ,yₛ). In some cases, a single seismic source (106) may be activated sequentially at each source location. In other cases, a plurality of seismic sources (106) each positioned at a different location may be activated sequentially. In accordance with one or more embodiments a plurality of seismic sources (106) may be activated during the same time period, or during overlapping time periods.

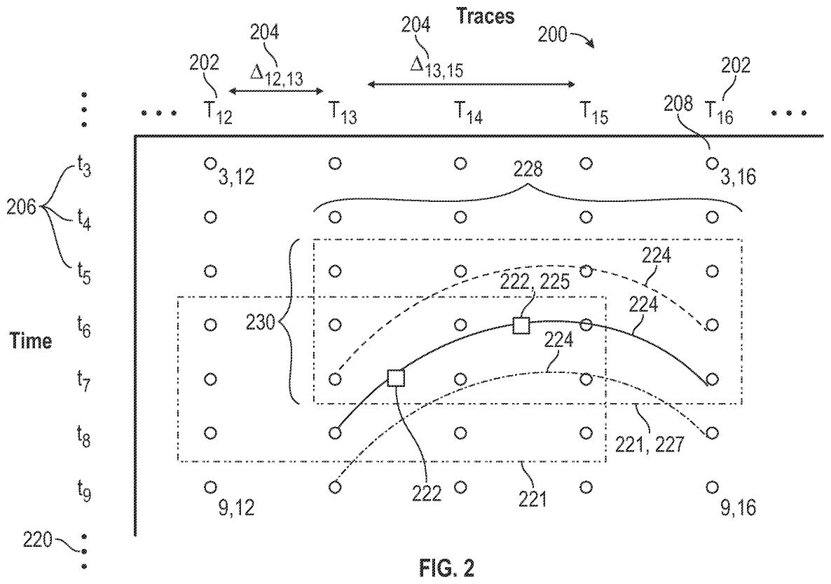

Once acquired, a seismic data set may undergo a myriad of processing steps. The purposes of these processing steps include, but are not limited to, reducing signal noise, identifying subterranean structures and surfaces, and data visualization. For simplicity and ease of visualization, FIG. 2 partially displays an abstract example of a generic 2D seismic data set (200), where recorded data values are represented with filled circles. The seismic data set (200) is 2D because, in this example, the seismic receivers (120) are placed in a single line on the surface, and time, containing information about the depth of subsurface reflectors, is displayed orthogonal to it. However, while FIG. 2 demonstrates a 2D seismic data set (200), this does not constitute a constraint on the dimensionality of a seismic data set (200). In general, a seismic data set may be 2D or 3D without departing from the scope of this disclosure.

Once processed, the seismic data set (200), which contains information to characterize and locate hydrocarbon reservoirs, may be used to plan and drill a wellbore to extract said hydrocarbons.

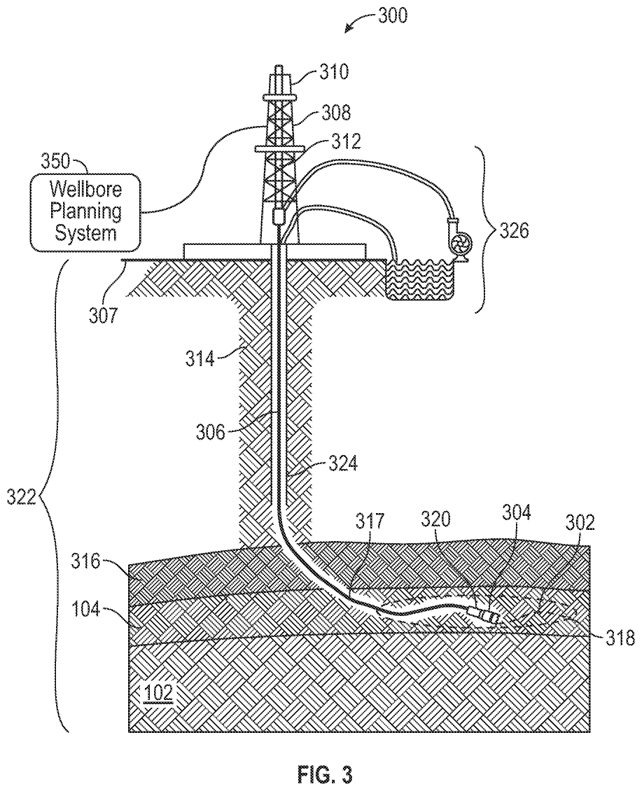

FIG. 3 shows a drilling system (300) in accordance with one or more embodiments. Although the drilling system (300) shown in FIG. 3 is used to drill a wellbore on land, the drilling system (300) may also be a marine wellbore drilling system. The example of the drilling system (300) shown in FIG. 3 is not meant to limit the present disclosure.

As shown in FIG. 3, a wellbore path (302) may be drilled by a drill bit (304) attached by a drillstring (306) to a drill rig located on the surface (307) of the earth. The drill rig may include framework, such as a derrick (308) to hold drilling machinery. The top drive (310) sits at the top of the derrick (308) and provides clockwise torque via the drive shaft (312) to the drillstring (306) in order to drill the wellbore. The wellbore may traverse a plurality of overburden (314) layers and one or more cap-rock (316) layers to a hydrocarbon reservoir (104) within the subterranean region of interest (102). In accordance with one or more embodiments, the seismic data set may be used to plan a wellbore including a wellbore path (302) and to drill a wellbore (317) guided by the wellbore path (302). The wellbore path (302) may be a curved wellbore path, or a straight wellbore path. All or part of the wellbore path (302) may be vertical, and some wellbore paths may be deviated or have horizontal sections.

Prior to the commencement of drilling, a wellbore plan may be generated. The wellbore plan may include a starting surface location of the wellbore, or a subsurface location within an existing wellbore, from which the wellbore may be drilled. Further, the wellbore plan may include a terminal location that may intersect with the target zone (318) (e.g., a targeted hydrocarbon-bearing formation) and a planned wellbore path (302) from the starting location to the terminal location. In other words, the wellbore path (302) may intersect a previously located hydrocarbon reservoir (104).

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. In accordance with one or more embodiments, the wellbore plan is informed by the processed seismic data set acquired through a seismic survey (100) conducted over the subterranean region of interest (102).

The wellbore plan may include wellbore geometry information such as wellbore diameter and inclination angle. If casing (324) is used, the wellbore plan may include casing type or casing depths. Furthermore, the wellbore plan may consider other engineering constraints such as the maximum wellbore curvature (“dog-log”) that the drillstring (306) may tolerate and the maximum torque and drag values that the drilling system (300) may tolerate.

A wellbore planning system (350) may be used to generate the wellbore plan. The wellbore planning system (350) may comprise one or more computer processors in communication with computer memory containing the geophysical and geomechanical models, the processed seismic data set, information relating to drilling hazards, and the constraints imposed by the limitations of the drillstring (306) and the drilling system (300). The wellbore planning system (350) may further include dedicated software to determine the planned wellbore path (302) and associated drilling parameters, such as the planned wellbore diameter, the location of planned changes of the wellbore diameter, the planned depths at which casing (324) will be inserted to support the wellbore and to prevent formation fluids entering the wellbore, and the drilling mud weights (densities) and types that may be used during drilling the wellbore.

A wellbore (317) may be drilled using a drill rig that may be situated on a land drill site, an offshore platform, such as a jack-up rig, a semi-submersible, or a drill ship. The drill rig may be equipped with a hoisting system, such as a derrick (308), which can raise or lower the drillstring (306) and other tools required to drill the well. The drillstring (306) may include one or more drill pipes connected to form conduit and a bottom hole assembly (BHA) (320) disposed at the distal end of the drillstring (306). The BHA (320) may include a drill bit (304) to cut into subsurface (322) rock. The BHA (320) may further include measurement tools, such as a measurement-while-drilling (MWD) tool and logging-while-drilling (LWD) tool. MWD tools may include sensors and hardware to measure downhole drilling parameters, such as the azimuth and inclination of the drill bit, the weight-on-bit, and the torque. The LWD measurements may include sensors, such as resistivity, gamma ray, and neutron density sensors, to characterize the rock formation surrounding the wellbore (317). Both MWD and LWD measurements may be transmitted to the surface (307) using any suitable telemetry system, such as mud-pulse or wired-drill pipe, known in the art.

To start drilling, or “spudding in” the well, the hoisting system lowers the drillstring (306) suspended from the derrick (308) towards the planned surface location of the wellbore (317). An engine, such as a diesel engine, may be used to supply power to the top drive (310) to rotate the drillstring (306). The weight of the drillstring (306) combined with the rotational motion enables the drill bit (304) to bore the wellbore.

The near-surface is typically made up of loose or soft sediment or rock, so large diameter casing (324), e.g., “base pipe” or “conductor casing.” is often put in place while drilling to stabilize and isolate the wellbore. At the top of the base pipe is the wellhead, which serves to provide pressure control through a series of spools, valves, or adapters. Once near-surface drilling has begun, water or drill fluid may be used to force the base pipe into place using a pumping system until the wellhead is situated just above the surface (307) of the earth.

Drilling may continue without any casing (324) once deeper, or more compact rock is reached. While drilling, a drilling mud system (326) may pump drilling mud from a mud tank on the surface (307) through the drill pipe. Drilling mud serves various purposes, including pressure equalization, removal of rock cuttings, or drill bit cooling and lubrication.

At planned depth intervals, drilling may be paused and the drillstring (306) withdrawn from the wellbore. Sections of casing (324) may be connected and inserted and cemented into the wellbore. Casing string may be cemented in place by pumping cement and mud, separated by a “cementing plug,” from the surface (307) through the drill pipe. The cementing plug and drilling mud force the cement through the drill pipe and into the annular space between the casing and the wellbore wall. Once the cement cures, drilling may recommence. The drilling process is often performed in several stages. Therefore, the drilling and casing cycle may be repeated more than once, depending on the depth of the wellbore and the pressure on the wellbore walls from surrounding rock.

Due to the high pressures experienced by deep wellbores, a blowout preventer (BOP) may be installed at the wellhead to protect the rig and environment from unplanned oil or gas releases. As the wellbore becomes deeper, both successively smaller drill bits and casing string may be used. Drilling deviated or horizontal wellbores may require specialized drill bits or drill assemblies.

A drilling system (300) may be disposed at and communicate with other systems in the well environment. The drilling system (300) may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus. Drilling may be considered complete when a target zone (318) is reached, or the presence of hydrocarbons is established.

Returning to FIG. 2, as noted, the seismic data set (200) is composed of a collection of traces (202) where each trace represents the amplitude of the signal recorded by an associated seismic receiver (120). The spatial distances (204) between each trace, which correspond to the spatial distances (204) between each seismic receiver (120) are known. Only a select few spatial distances (204) are shown in FIG. 2 for brevity. Each trace (202) contains a time series of amplitude values at sample or recorded times (206). The amplitude values are hereafter referred to as seismic data points (208) and are represented by the filled circles in FIG. 2. For clarity, only select seismic data points (208) are subscripted according to their associated time (206) and trace (202), however, each seismic data point (208) does have an implicit subscript. For example, the data point with the subscript “3,16” is the seismic data point (208), or signal value, of the trace (202) labelled “16” at time (206) labelled “3.” Additionally, FIG. 2, should be considered as a window into the entire seismic data set (200), which is not inclusive of every value in a seismic data set (200), as indicated by the arbitrary trace (202) subscripts, arbitrary time (206) subscripts, and ellipses (220).

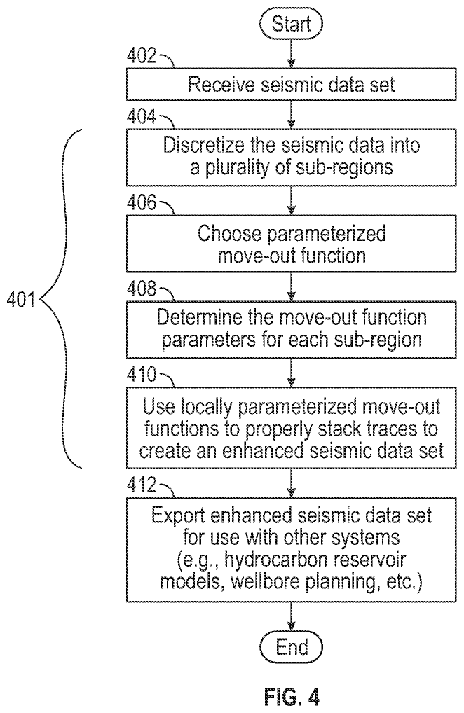

One processing technique that may be applied to a seismic data set (200) is non-linear beamforming (NLBF). FIG. 4 provides a general, high-level overview of the steps which may be taken during, and surrounding, a conventionally-performed NLBF procedure. As shown in Block 402, the first step is to receive a seismic data set (200). Once the seismic data set (200) is received, in Block 404, the seismic data set is discretized. Typically, the discretization is both temporal and spatial. The discretization splits the seismic data set (200) into sub-regions, which may be overlapping, disjoint, or exclusive. Each sub-region is associated with a move-out function that is parameterized by one or more parameters. In Block 406, the mathematical form of the move-out function is chosen. In general, different move-out functions of various forms may be selected for different sub-regions of discretized seismic data set (200). However, in practice, the move-out function has the same mathematical form for each of the sub-regions in the plurality of sub-regions. Greater detail regarding the move-out function is provided later in the instant disclosure. In Block 408, the one or more parameters of the move-out functions for each sub-region are determined. In one aspect, embodiments disclosed herein relate to a method of determining the one or more parameters for all the move-out functions of a given seismic data set (200). Greater descriptions of embodiments of this method of determining the parameter(s) of a collection of move-out functions (one for each sub-region) are provided later in the instant disclosure. Keeping with FIG. 4, in Block 410, using the one or more determined parameters for each move-out function (one for each sub-region), the traces (202) of the seismic data set (200) are stacked accordingly to create an enhanced seismic data set. In Block 412, the enhanced seismic data set may be exported for further processing or use, for example, to inform a geological model or wellbore planning system (350). The general NLBF procedure (401) comprises the steps from discretization (Block 404) to the creation of the enhanced seismic data set (Block 410).

Each step of the NLBF procedure (401) is further described. As seen in FIG. 4, spatial and temporal sub-regions are determined by discretizing (Block 404) the seismic data set (200) according to a user. As an example, two select sub-regions (221) are depicted in FIG. 2. As shown in FIG. 2, the sub-regions may be overlapping, disjoint, or exclusive. In one or more embodiments, the discretization, or the distribution of sub-regions, is specified through a sub-region aperture size, sub-region spatial stride(s), and sub-region temporal stride. The sub-region aperture size specifies the size of the sub-region in both the spatial and temporal directions. In one or more embodiments, the sub-region aperture size may be specified by a sub-region temporal aperture and sub-region spatial aperture(s). The sub-region temporal stride and the sub-region spatial stride(s) indicate the temporal and spatial distance between the centers of adjacent sub-region apertures. In other embodiments, the size and spacing of sub-regions may not be uniform. Generally, each sub-region is centered around a point (x₀,y₀,t₀) referenced herein as a local origin point (222) which will be described in greater detail on continuation.

It is not uncommon for a single seismic data set (200) to be discretized into millions, if not billions, of spatial and temporal sub-regions. Here, it is emphasized that one or more move-out function parameters are determined for each sub-region. In other words, each sub-region is associated with a move-out function parameterized by one or more parameters and the one or more parameters must be determined for each move-out function. Because a move-out function with its own set of one or more parameters exists for each sub-region, it may be said the move-out functions are locally parameterized. That is, the one or more parameters describing a move-out function are determined with respect to their associated sub-region and are thus “local” to that sub-region.

Upon discretization of a seismic data set (200) a parameterized move-out function must be chosen. In accordance with one or more embodiments, the move-out function of a sub-region associated with a point at (x₀,y₀,t₀) in a 3D seismic data set (200) is chosen as the second-order function

$$Δ t ( x , y ; {x}_{0} , {y}_{0} , {t}_{0} ) = t ( x , y ) - t ( {x}_{0} , {y}_{0} ) = A Δ x + B Δ y + C Δ x Δ y + D Δ {x}^{2} + E Δ {y}^{2} , \qquad ( 1 )$$

where t(x,y) is the traveltime of the trace (202) located at a position (x,y) in a seismic data set (200), t(x₀,y₀) is the traveltime of a NLBF trace located at a position (x₀,y₀), and the coefficients A, B, C, D and E are the parameters of the move-out function. That is, using EQ. 1, each move-out function is parameterized by five parameters. The NLBF trace is a proposed trace that may, or may not, coincide in position with a trace (202) of the seismic data set (200). That is (x₀,y₀) need not equal any (xᵣ,yᵣ). As stated, when performing the NLBF procedure (401), there is a move-out function associated with each sub-region of the discretized seismic data set (200). In one or more embodiments, an individual sub-region is centered around the local origin point (222), (x₀,y₀,t₀). That is, the exact values for (x₀,y₀,t₀) are dependent on the sub-region associated with the move-out function. Δx and Δy represent the distance between x and x₀, and between y and y₀, respectively. Mathematically, Δx=x−x₀, and Δy=y−y₀. Concretely, Δx and Δy represent the spatial distance between traces (202) located at positions (x,y) and (x₀,y₀), along their respective axes, and are analogous to the generic spatial distance Δ (204) seen in FIG. 2. Provided a sub-region (i.e., given a local origin point (222), (x₀,y₀,t₀)), EQ. 1 may be considered a two-dimensional function (i.e., a function of two variables; namely x and y) but may be readily adjusted for use in one dimension, for example, to be used with the seismic data set (200) of FIG. 2, or higher dimensions. In other embodiments, EQ. 1 may be a first-order function or a higher-order function such as a third-order function. Alterations of this nature may reduce or increase the number of parameters used in the move-out functions.

Conventionally, the one or more parameters for each of the move-out functions are determined using a non-linear solver, applied independently to each sub-region, to optimize an objective function over various values for the one or more parameters. An example objection function is the semblance-like function

$$S ( {x}_{0} , {y}_{0} , {t}_{0} ) = \frac{{{\sum }_{j ∈ TA} [ {\sum }_{( x , y ) ∈ SpA} u ( x , y , {t}_{j} + Δ t ( x , y ; {x}_{0} , {y}_{0} , {t}_{0} ) ) ]}^{2}}{{N}_{SpA} {\sum }_{j ∈ TA} [ {\sum }_{( x , y ) ∈ SpA} u {( x , y , {t}_{j} + Δ t ( x , y ; {x}_{0} , {y}_{0} , {t}_{0} ) )}^{2} ]} , \qquad ( 2 )$$

where greater values of this objective function correspond to increased coherence among the time-series data, or traces (202), collected over multiple seismic receivers (120). In EQ. 2, u(x,y,t) references the value of the trace (202) collected by a seismic receiver (120) located at position x, y at time t. As seen, EQ. 2 is dependent on the move-out function of a given sub-region. That is, EQ. 2 references Δt(x,y;x₀,y₀,t₀). As such, EQ. 2 can be optimized over the one or more parameters associated with the move-out function of the sub-region. EQ. 2 performs summation operations over time-shifted traces (202), where the time shift is conducted according to the local move-out function. The summations of EQ. 2 operate over a so-called spatial aperture (SpA) and temporal aperture (TA). The spatial aperture (SpA) and temporal aperture (TA), together, enclose a set of seismic data points (208) to be used when computing the semblance-like objective function. In many instances the spatial aperture (SpA) and temporal aperture (SpA) enclose the set of seismic data points (208) uniquely contained within the referenced sub-region. However, in general, the sub-region and the region defined by the spatial aperture (SpA) and temporal aperture (TA) need not be the same.

FIG. 2, will provide a concrete example into the inner workings of EQ. 2. FIG. 2 shows the location of a first local origin point (225) which is u(x₀,y₀,t₀) in EQ. 2 and corresponds to a first sub-region (227). As stated, the location of the first local origin point (225) need not coincide with any seismic data point (208) in the seismic data set (200) spatially or temporally. FIG. 2 also depicts a first spatial aperture (SpA) (228) and a first temporal aperture (TA) (230) corresponding to the first sub-region (227). As seen, in the example of FIG. 2, the region defined by the first spatial aperture (SpA) (228) and first temporal aperture (TA) (230) directly coincides with the first sub-region (227). While the example of FIG. 2 depicts the region defined by the first spatial aperture (SpA) (228) and first temporal aperture (TA) (230) to directly coincide with the first sub-region (227), it is emphasized that this is not a requirement. Similarly, while it is also noted that the spatial aperture (SpA) and temporal aperture (TA) of a given sub-region are likely chosen to encompass the local origin point (222) of a given sub-region, this is also not a requirement. An arbitrary second-order move-out surface (224), with various time-shifts over the first temporal aperture (TA) (230) and spanning the first spatial aperture (SpA) (228) is shown in FIG. 2.

Because EQ. 2 is continuous valued and the seismic data points (208), as referenced by u(x,y,t), are discrete, the substitution of EQ. 1 (i.e., move-out function Δt) into EQ. 2 may result in a term u(x,y,tⱼ+Δt) wherein (tⱼ+Δt) does not correspond to an actual time (206) present in the seismic data set (200). Here, it is noted that the functional dependence of Δt on x, y, x₀, y₀, and to is omitted for brevity and without ambiguity. In this case, one skilled in the art will acknowledge that a value u may be obtained at an arbitrary time (tⱼ+Δt) by interpolative methods; including simply using the value of u(x,y,t) where t is the time (206) actually present in the seismic data set (200) nearest to (tⱼ+Δt).

It is emphasized that EQ 2. is provided only as an example and is only relevant to one parameterization of the move-out surface (224) for a single sub-region (e.g., first sub-region (227)) as displayed in FIG. 2.

Keeping with the NLBF procedure (401), once the one or more parameters for each of the move-out functions (one for each sub-region) have been determined, the move-out functions are used to stack traces of the seismic data set (200) to form an enhanced seismic data set. In general, the enhanced seismic data set is a collection of NLBF-enhanced traces, where there is one NLBF trace at every local origin point (222) (i.e., an NLBF trace for each sub-region). A NLBF-enhanced trace is determined by summing time-shifted seismic data across multiple seismic receivers (120) and the summation is typically of the form

$$u ( {x}_{0} , {y}_{0} , {t}_{0} ) = {\sum }_{( x , y ) ∈ SA} w ( x , y , {t}_{0} ) u ( x , y , {t}_{0} + Δ t ( x , y ; {x}_{0} , {y}_{0} , {t}_{0} ) ) , \qquad ( 3 )$$

where u is the seismic data point (208) from a seismic receiver (120) located at position x and y, and at time t, w is the beamforming weights, and Δt is the move-out function (with one or more determined parameters) of the sub-region associated with the point (x₀,y₀,t₀).

Note that EQ. 3 is readily applicable to a 3D data set but may be reduced to operate on a 2D seismic data set (200) or extended to higher dimensions. Additionally, while the beamforming weights w are listed as a function of position, they are more likely a function of relative position Δx, Δy, where Δx=x−x, and Δy=y−y₀, respectively, in practical situations. The beamforming weights w may be chosen in many ways to enhance the signal and suppress noise. The summation in EQ. 3 is taken over all traces (202) with positions (x,y) contained within the summation aperture (SA), which is typically a local region surrounding (x₀,y₀, to).

In summary, upon determining the one or more parameters for each move-out function (one for each sub-region) the move-out functions are used to calculate appropriate time shifts in the seismic data set (200). Using local time-shifts, an enhanced seismic data set is produced by collecting NLBF-enhanced traces, where each NLBF-enhanced trace is calculated according to the summation of EQ. 3. The enhanced seismic data set may be used immediately, exported for use in another system such as a wellbore planning system (350), or further processed.

As stated, the conventional method for determining the one or more parameters for a given move-out function of a sub-region is to use a non-linear solver to optimize an objective function (e.g., EQ. 2). It is stated that the objective function of EQ. 2 is highly non-linear and that solving for the one or more parameters of a given move-out function (e.g., A, B, C, D and E of EQ. 1) is non-trivial. Commonly employed non-linear solvers include, but are not limited to: the 2+2+1 local search method; the 5D brute force method; and sequential dips and curvatures estimation. Many non-linear solvers make use of iterative procedures and require many function calls. Further, the non-linear solver must be used to determine the one or more move-out function parameters for each sub-region, of which there may be millions, or even billions, for a given seismic data set (200). Consequently, determining the one or more move-out function parameters for each sub-region is computationally expensive and time-consuming, if not prohibitive.

There are two immediate ways to lower the computational cost of the NLBF procedure (301): by reducing the number of sub-regions or by reducing the need to use a non-linear solver for, at least some, of the sub-regions. While reducing the number of sub-regions decreases the computational cost, it also reduces the quality of the resulting enhanced seismic data set. In one or more of the embodiments disclosed herein, a convergent alternating projection onto convex sets (convergent POCS, or CP) method is used to determine the one or more move-out parameters for a portion of the sub-regions such that the use of a non-linear solver is not required for this portion of sub-regions. As will be described in greater detail, the percentage of sub-regions where the associated move-out function parameters are determined using a non-linear solver is defined herein as R. Therefore, the one or more move-out function parameters associated with (100−R) % of the sub-regions are determined using the CP method, which is relatively computationally cheap compared to the use of a non-linear solver. Further, the CP method operates over all (100−R) % of the sub-regions simultaneously.

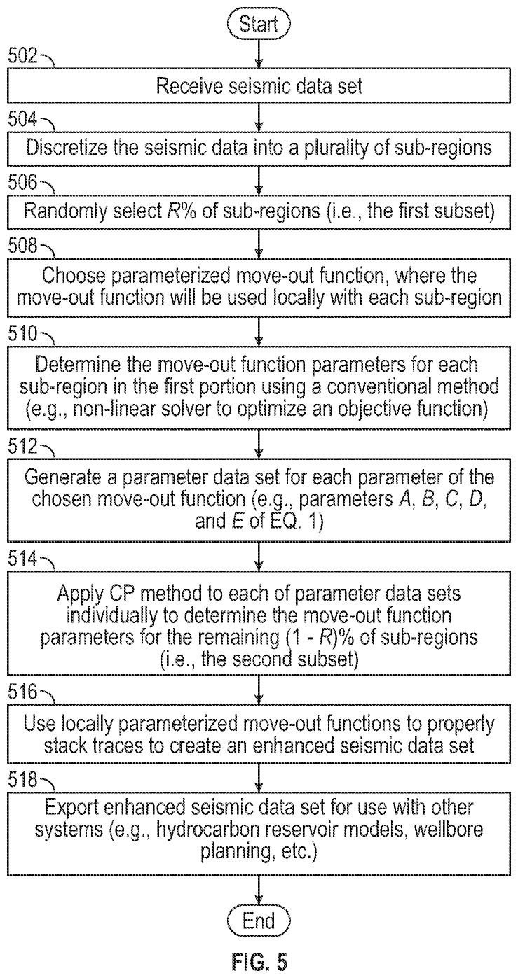

In accordance with one or more embodiments, FIG. 5 depicts a high-level overview of the steps which may be taken during, and surrounding, an NLBF procedure similar to FIG. 4 but using the CP method to solve for the one or more move-out function parameters associated with a portion of the sub-regions. It is noted that a few of the steps, or blocks, of FIG. 5 are identical to the steps of FIG. 4, however, a unique label is applied to these steps to avoid ambiguity as to which figure (FIG. 4 or FIG. 5) is being referenced. In FIG. 5, in Block 502, a seismic data set (200) is received (identical to Block 402 of FIG. 4). In Block 504, the seismic data set (200) is discretized into a plurality of sub-regions (identical to Block 404 of FIG. 4). In Block 506, R % of the sub-regions are randomly selected, where the value of R is provided by a user and 0<R≤100. In one or more embodiments, 25≤ R≤50. The R % of randomly selected sub-regions are hereafter referred to as the “first subset” of the plurality of sub-regions. The remaining (100−R) % of sub-regions are hereafter referred to as the “second subset.” Thus, each sub-region in the plurality of sub-regions exclusively belongs to either the first subset or the second subset. In Block 508, a parameterized move-out function is chosen. As previously discussed, under the conventional NLBF procedure of FIG. 4, technically, different types of move-out functions could be used for different sub-regions in the plurality of sub-regions. For the NLBF procedure that employs the CP method, the move-out function of each sub-region must be of the same type (or mathematical form). In Block 510, the move-out function parameters for each sub-region in the first subset are determined using a conventional method (e.g., by optimizing an objective function using a non-linear solver). It is emphasized that under the conventional NLBF procedure (e.g., FIG. 4), the move-out function parameters for all the sub-regions in the plurality of sub-regions are determined using a conventional method, however, under the CP-enhanced NLBF procedure of FIG. 5, the computationally expensive conventional method is only applied to the first subset of sub-regions. In Block 512, a parameter data set for each parameter of the chosen move-out function is generated. For example, if the move-out function is chosen to be after the form of EQ. 1 then there are five parameter data sets, one for each of the move-out function parameters A, B, C, D, and E.

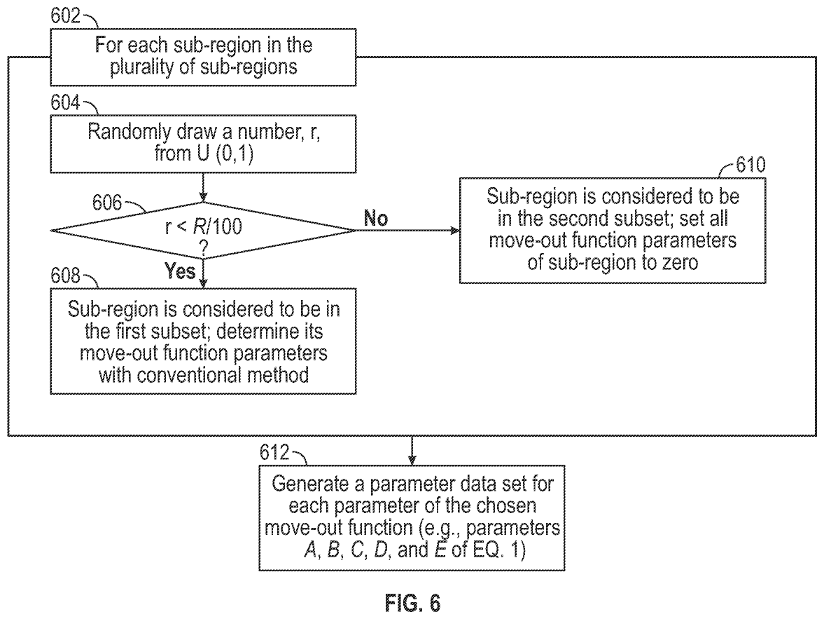

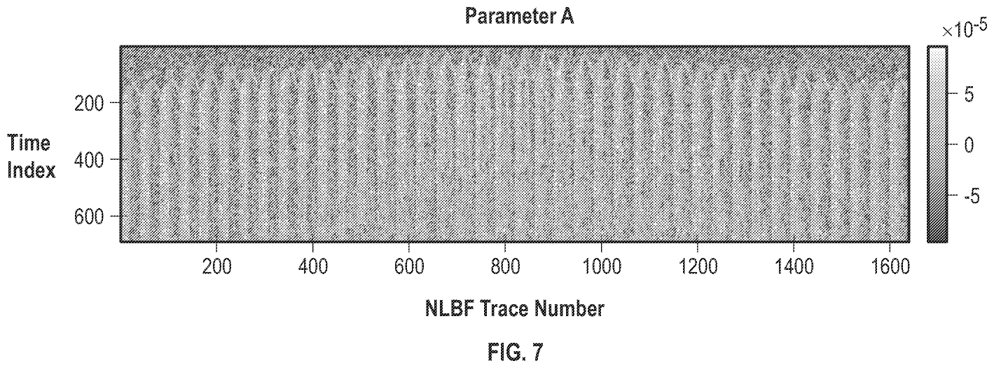

FIGS. 6 and 7 provide greater details about how sub-regions are randomly selected and assigned to either the first subset or the second subset and the structure of a parameter data set, respectively, in accordance with one or more embodiments. FIG. 6 roughly corresponds with Blocks 506-512 of FIG. 5. Thus, it is noted that the steps depicted in FIG. 6 assume that a seismic data set (200) has been received and discretized into a plurality of sub-regions. Block 602 of FIG. 6 indicates that the enclosed procedure is to be applied to each sub-region in the plurality of sub-regions independently. In Block 604, for a given sub-region, a number, r, is randomly drawn from a uniform distribution between 0 and 1. In Block 606, if the randomly drawn number, r, is less than R/100 then the given sub-region is considered to be in the first subset and its associated move-out function parameters are determined using a conventional method, as shown in Block 608. However, if the randomly drawn number, r, is greater than or equal to R/100 then the given sub-region is considered to be in the second subset and all of its associated move-out function parameters are set to zero (Block 610). The move-out function parameters of the sub-regions in the second subset are to be solved using the CP method. Thus, it can be seen that the user-specified percentage number R represents the desired percentage of sub-regions in the plurality of sub-regions that are to be solved using a conventional method. In Block 612 (equivalent to Block 512), once all of the sub-regions in the plurality of sub-regions have been considered, and their associated move-out parameters either determined or set to zero, the move-out function parameters of all the sub-regions in the plurality of sub-regions are collected to generate parameter data sets, one for each of the move-out function parameters.

The concept of a parameter data set is best considered by example. Consider the case where the chosen move-out function (Block 508) is of the form of EQ. 1 and is parameterized by five parameters A, B, C, D, and E. Then, to perform an NLBF procedure, A, B, C, D, and E must be determined for each sub-region in the plurality of sub-regions. In other words, there is a Parameter A associated with each sub-region, a Parameter B associated with each sub-region, etc. A parameter data set contains the values for a single parameter across all sub-regions. Consider the case where a move-out function is chosen after the form of EQ. 1 and a user has specified the value of R to be 30. FIG. 7, depicts an example of parameter data set for the Parameter A formed according to the processes of FIGS. 5 and 6, as described so far. As seen in FIG. 7, roughly 70% ((100−R) % where R=30) of the sub-regions in the Parameter A data set have a value of zero, where these correspond to the sub-regions that were randomly selected to belong in the second subset. Note that the parameter data structure of FIG. 7 is structured to preserve the spatial and temporal relationships of the associated sub-regions. That is, the parameter data set is structured according to a time index and NLBF trace index (i.e., local origin points (222)). Parameter data sets for the parameters B, C, D, and E are generated in a similar manner.

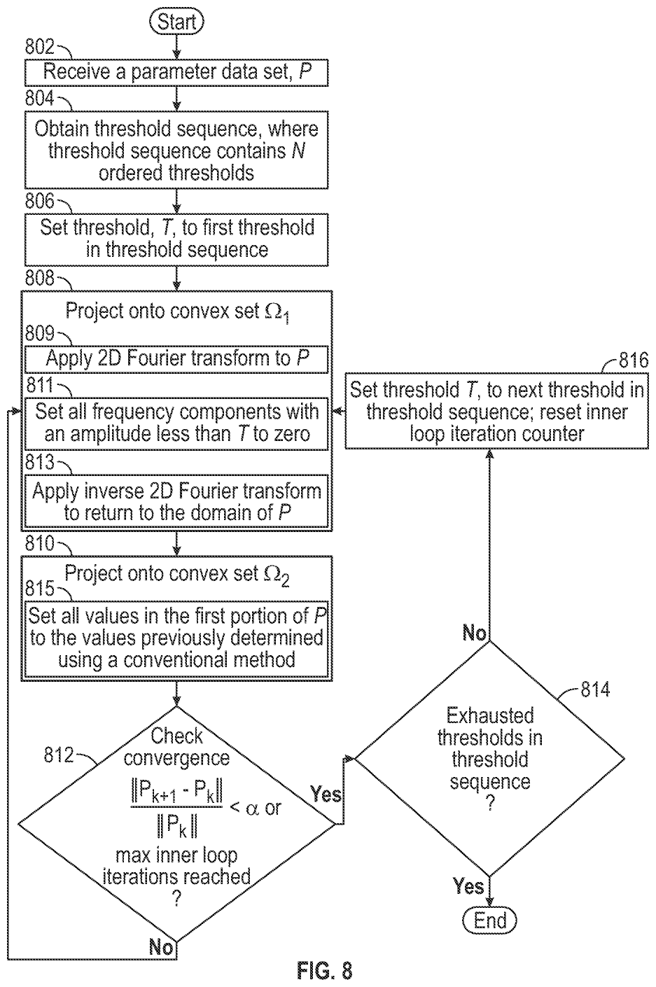

Returning to FIG. 5, in Block 514, the convergent POCS (CP) method is applied to each of the parameter data sets (one for each parameter of the chosen move-out function) individually to determine the values for its associated parameter in every sub-region in the second subset. An outline of the CP method applied to a given parameter data set is depicted in FIG. 8, in accordance with one or more embodiments. In Block 802, a parameter data set, P, is received. For example, the parameter data set, P, may be the parameter data set for the Parameter A, as depicted in FIG. 7. Note that the parameter data set, P, will have a first subset of sub-regions with already determined values and a second subset of sub-regions where the values have been set to zero.

In Block 804, a threshold sequence is obtained. In one or more embodiments, the threshold sequence is an array of N ordered thresholds where N is an integer greater than or equal to 1. The threshold sequence may be represented as T with elements [T₁, T₂, . . . , Tₙ, . . . , T_{N}] where Tₙ is a single threshold value. The threshold sequence is considered ordered because Tₙ₊₁ always comes after Tₙ. The threshold values must be greater than zero and, as a further constraint, T₁>T₂> . . . >Tₙ> . . . >T_{N}. In one or more embodiments, the thresholds of the threshold sequence are specified by an exponential decay function. In other embodiments, the thresholds of the threshold sequence decrease uniformly with n.

In Block 806, a threshold T is set to the first threshold in the threshold sequence. That is, in Block 806, T=T₁. In Block 808, the parameter data set, P, is projected onto a convex set Ω₁. A full review of convex sets exceeds the scope of this disclosure, however, a brief summary of concepts dealing with convex sets is provided. Mathematically, in a vector space a set Ω is considered convex if and only if for any two vectors, x and y, each in the convex set Ω (i.e., ∀\vec{x}∈Ω and ∀\vec{y}∈Ω), the following equation holds,

$$λ \vec{x} + ( 1 - λ ) \vec{y} ∈ Ω ; ∀ 0 \leq λ \leq 1. \qquad ( 4 )$$

In layman's terms, EQ. 4 defines a convex set as a set with the following property: given any two points, each within the set, and a straight line connecting these two points, no part of the straight line exits the set. Many categories of convex sets exist. For example, a non-exhaustive list of classes of convex sets may include: fixed area signal, identical middles, and bandlimited signals. Additionally, convex sets may be parameterized. That is, given a class of convex sets, a parameter may further specify the extent and/or nature of a convex set. For example, a fixed area signal convex set is fully specified by a fixed area parameter that indicates the sum of the vector elements for every vector in the fixed area convex set. It is noted that while the definition of a convex set provided in EQ. 4 is under the context of vector spaces, the concept of convex sets may be generalized to higher dimensions and so-called function spaces and/or Hilbert spaces.

Continuing with the example of convex sets in vector spaces, for any point outside a convex set, there is a unique point in the convex set that is nearest to the outside point, where distance between points is determined with the L₂-norm. A point outside a convex set may be projected onto the convex set by moving the outside point to its nearest point on the convex set. In the event that a projection is applied to a point already on the convex set, the projection leaves said point unchanged.

An intersection of two convex sets is also a convex set. Provided two convex sets have an intersection, and given an initial starting point outside the intersection, a scheme which alternates projections between the two convex sets is guaranteed, in the limit, to end up at a point in the intersection of the two convex sets. It is noted that the location of the initial starting point determines the point on the intersecting convex set that the process of alternating projections converges to, but convergence is guaranteed in the limit. Additional discussion regarding alternating projections between more than two convex sets and instances where groups of convex sets do not have an intersection are beyond the scope of this summary. However, one skilled in the art will recognized that the preceding discussion is more than sufficient to describe the remaining components of the CP method described herein, in accordance with one or more embodiments.

Returning to FIG. 8, as stated, in Block 808 the parameter data set, P, is projected onto a convex set Ω₁. The convex set Ω₁ is defined as

$${Ω}_{1} = \{ p \vert \vert {ℱ ( p )}_{j} \vert = 0 or \vert {ℱ ( p )}_{j} \vert \geq T ∀ j \} . \qquad ( 5 )$$

In EQ. 5, p is a parameter data set and [symbol] (·) indicates a Fourier transform. Thus, [symbol] (p) represents the result of a Fourier transform applied to the parameter data set p. In accordance with one or more embodiments, the parameter data set p is structured as a two-dimensional array (e.g., Parameter A in FIG. 7). The 2D Fourier transform returns a two-dimensional array of complex-valued frequency components. Herein, frequency components are uniquely indexed with the index j, where j spans all the frequency components of [symbol] (p). Therefore, [symbol] (p)ⱼ references a single frequency component upon applying a 2D Fourier transform to the parameter data set p. EQ. 5 states that Ω₁ is the set of all parameter data sets such that, upon taking the 2D Fourier transform of any parameter data set in the set 221, the amplitudes of all the resulting frequency components are either 0 or greater than or equal to a value T, where T is a parameter that parameterizes the set 221.

Given the definition of the convex set Ω₁ in EQ. 5, Block 808 further encloses the steps required to project a given parameter data set, P, onto the complex set Ω₁(T). The notation Ω₁(T) is intended to emphasize that Ω₁ is parameterized by the threshold parameter T. As shown in Block 809, the 2D Fourier transform is applied to P, resulting in the two-dimensional array of complex-valued frequency components [symbol] (P). In Block 811, all frequency components of [symbol] (P) with an amplitude less than the supplied threshold parameter T are set to zero. In Block 813, an inverse 2D Fourier transform is applied to return the amplitude-altered [symbol] (P) back to the domain of the parameter data set, P. Thus, Block 808 encloses all the steps necessary to project the parameter data set, P, onto the convex set Ω₁(T), where Ω₁ is parameterized by the threshold T set in Block 806. Hereafter, P_{Ω}_{₁} will be used to indicate that the parameter data set, P, has been projected onto the convex set Ω₁(T).

Continuing with the process outlined in FIG. 8, in Block 810 P_{Ω}_{₁} is projected onto convex set Ω₂. The convex set Ω₂ is defined as

$${Ω}_{2} = \{ p \vert {p}_{j} = {q}_{j} ∀ j ∈ first subset \} , \qquad ( 6 )$$

where q represents the originally generated parameter data set (see Block 612 of FIG. 6) where all the sub-regions considered to be part of the first subset have had their parameters determined using a conventional method. Again, like in EQ. 5, j is used as an index and in EQ. 6 j spans all the sub-regions of the parameter data set p that are were determined to be in the first subset. Because the convex set (22 is reliant upon the previously determined parameter values for the sub-regions of the first subset, it may be said that (22 is parameterized by the first subset.

As shown in Block 815, P_{Ω}_{₁} is projected onto Ω₂ by replacing the values in the parameter data set associated with sub-regions of the first subset with the values previously determined using a conventional method (see Block 608 of FIG. 6).

Next, in Block 812, a convergence criterion is checked. In accordance with one or more embodiments, the convergence criterion is

$$\frac{‖ {P}_{k + 1} - {P}_{k} ‖}{‖ {P}_{k} ‖} < α or K inner loop iterations reached . \qquad ( 7 )$$

Careful inspection of the flowchart of FIG. 8 reveals an “outer loop” and an “inner loop.” The inner loop cycles between Blocks 808 and 812 of FIG. 8, where the loop returns to Block 808 from Block 812 if the convergence criterion of EQ. 7 is not satisfied. In one or more embodiments, each iteration of the inner loop (the application of Blocks 808 and 810) is counted with an iteration counter k, where k is initially set to zero. Thus, P₀ references the parameter data set, P, as it first enters Block 808, P₁ references the parameter data set, P, after a first iteration through the inner loop (i.e., Blocks 808 and 810), and so on and so forth, until P_{K} represents the parameter data set, P, after a max of K iterations. K is a max inner loop iterations threshold specified by a user. Likewise, α is a convergence threshold value specified by the user. In general, smaller values for α will require more iterations before convergence is satisfied. Further, it is noted that α is required to be greater than zero and that, in practical applications, α should be above the numerical precision of a computer system used to determine convergence. Thus, EQ. 7 states that if the normalized root mean squared difference between consecutive iterations of the inner loop is less than the convergence threshold a or if the inner loop has achieved the max inner loop iterations threshold, K, the inner loop should be terminated. Once an instance of the inner loop is terminated (i.e., convergence satisfied in Block 812), Block 814 checks if any more threshold values remain in the threshold sequence, T. If not all of the threshold values in the threshold sequence have been used, then the threshold, T, is updated to the next threshold in the threshold sequence in Block 618. Additionally, in Block 618, the inner loop iteration counter, k, is reset (i.e., set to zero) and the parameter data set. P, is again processed by the inner loop of Blocks 808 and 810 until convergence is achieved. Updating the threshold, T, until all threshold values in the threshold sequence have been exhausted constitutes the outer loop (Blocks 808 to 816). Once all the thresholds in the threshold sequence have been used, Block 814 ends the process of FIG. 8. In one or more embodiments, the max inner loop iterations threshold, K, is set to infinity (or the largest value allowed by the precision of a computer), or otherwise nullified such that the convergence criterion only depends on the term

$$\frac{‖ {P}_{k + 1} - {P}_{k} ‖}{‖ {P}_{k} ‖} < α .$$

Setting the max inner loop iterations threshold, K, to infinity such that the convergence criterion only depends on the term

$$\frac{‖ {P}_{k + 1} - {P}_{k} ‖}{‖ {P}_{k} ‖} < α$$

is possible because convergence is guaranteed based on the convex sets used herein and defined in EQs. 5 and 6. In other embodiments the value of max inner loop iterations threshold. K, is set to one such that the threshold. T, is updated after every pair of alternating projections (i.e., projection onto Ω₁ and projection onto Ω₂).

To further aid understanding, the CP method as depicted in FIG. 8. is represented below with pseudo-code. In Line 1, the threshold sequence, T, is received. The threshold sequence contains N threshold values and is ordered. In Line 2, a variable P_{old} is initialized and assigned the values of the parameter data set, P, the CP method is operating on. Line 3 defines the iteration counter for the outer loop. In Line 4, for each iteration of the outer loop, a variable named threshold is updated with a threshold value from the threshold sequence. In Line 5, the iteration counter for the inner loop is assigned a value of 0. In Line 6, a variable C is initialized to a value of infinity (or the largest value numerically allowed by the computer implementing the instructions of the pseudo-code). The variable C will store a convergence value according to EQ. 7. Line 7 tests the convergence criterion to decide if the inner loop should be implemented. So long as the convergence value, C, is greater than or equal to the convergence threshold, a, and the max inner loop iterations threshold, K, hasn't been reached, the inner loop is executed. In Line 8, the variable P_{old} is projected to the convex set Ω₁ where it is emphasized that the convex set Ω₁ is parameterized by the threshold variable. In Line 9, the result of Line 8 is projected to the convex set £22, where it is emphasized that the convex set £22 is parameterized by the values of the parameter data set, P, associated with sub-regions in the first subset. In Line 10, the convergence value, C, is determined according to EQ. 7 by comparing the parameter data set between subsequent iterations. In Line 11, the variable P_{old} is updated. Finally, in Line 12, the inner loop counter is incremented.

Convergent pocs (cp) pseudo-code

| | |
|---|---|
| 1: | T = [T₁, T₂, ... , Tₙ , ... , T_{N} ] ∈ [symbol] ^{N}; T₁ > T₂ > ... > Tₙ > ... > T_{N} |
| 2: | P_{old} = P |
| 3: | for t ← 1 to N |
| 4: | threshold = Tₜ |
| 5: | k = 0 |
| 6: | C ← ∞ |
| 7: | while C ≥ α and k < K |
| 8: | P_{new} = projection_Ω₁(P_{old}; threshold) |
| 9: | P_{new} = projection_Ω₂(P_{new}; P_first subset) |
| 10: | $C = \frac{‖ {P}_{new} - {P}_{old} ‖}{‖ {P}_{old} ‖}$ |
| 11: | P_{old} = P_{new} |
| 12: | k = k+1 |

Returning to the CP-enhanced NLBF procedure of FIG. 5, it is emphasized that a parameter data set for each parameter of the chosen move-out function is generated as shown in Block 512. In Block 514, the CP method of FIG. 8 is applied to each parameter data set individually and independently. Thus, the result of Block 514 is a set of parameter data sets, one for each parameter of the chosen move-out function, with completely determined parameter values for all the sub-regions in the plurality of sub-regions (i.e., the first subset and the second subset). In Block 516, the locally parameterized move-out functions are used to properly stack the traces of the seismic data set (200) to create an enhanced seismic data set (identical to Block 410 of FIG. 4). In Block 518 the enhanced seismic data set is exported for use with other systems (e.g., hydrocarbon reservoir models, wellbore planning systems, etc.) (identical to Block 412 of FIG. 4).

In summary, under the CP-enhanced NLBF procedure it is only required to determine the one or more move-out function parameters for R % of the sub-regions with a computationally expensive conventional method (i.e., non-linear solver). The one or more parameters of the remaining (100−R) % of the sub-regions are determined, parameter by parameter (i.e., for each parameter data set), using the CP method, which is relatively computationally cheap compared to the use of a non-linear solver. Further, the CP method operates over all (100−R) % of the sub-regions for a given parameter data set simultaneously.

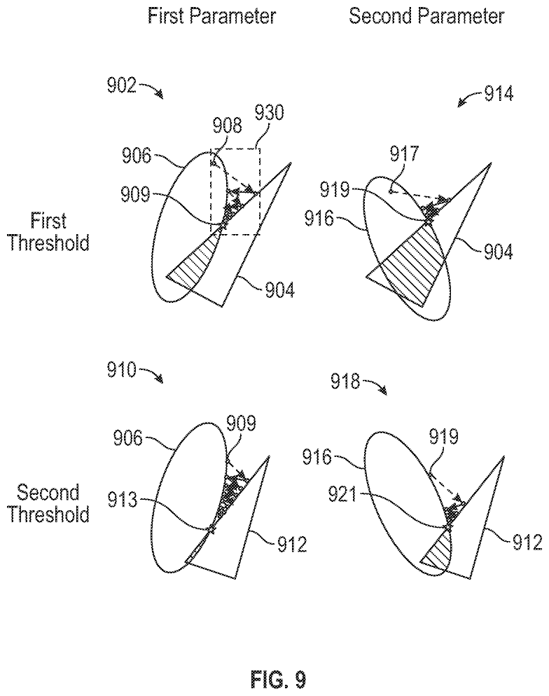

FIG. 9 graphically depicts aspects of the CP method, in accordance with one or more embodiments. Consider the case where the chosen move-out function (Block 508) is parameterized by at least two parameters. For the present example, these parameters are referred to as the first parameter, the second parameter, and so forth. Using the processes previously described herein, a parameter data set is generated for each of the at least two parameters. The parameter data sets are referred to as the first parameter data set, the second parameter data set, and so forth. Further, the threshold sequence contains at least two threshold values, similarly referred to as the first threshold, second threshold, etc. FIG. 9 illustrates various alternating projections between convex sets. It is noted that the convex sets shown in FIG. 9 are given only as an example and serve as abstractions for the projections of the CP method (i.e., the convex sets of FIG. 8 cannot be represented as 2D shapes).

FIG. 9 depicts a first instance (902) where the first parameter data set is alternately projected between a first convex set (904) and a second convex set (906). The first convex set is parameterized by the first threshold and is analogous to convex set 221. The second convex set (906) is parameterized by the first subset of the first parameter data set and is analogous to convex set Ω₂. The first parameter data set, with a first subset determined with a conventional method and a zero-valued second subset is initially located at the first point (908). Again, the use of points and 2D shapes to represent the space of the first parameter data set and associated convex sets is provided for illustrative purposes only. As seen in the first instance (902), the first point (908) is located within the second convex set (906) (by definition) but is not located within the first convex set (904) (note, it would be extremely unlikely for a parameter data set to initially reside in Ω₁). The directed arrows indicate projections to the convex sets. As seen in the first instance (902), the first point (908) is alternately projected between the first convex set (904) and the second convex set (906) until the first parameter data set converges at a first intersection (909).

The second instance (910) of FIG. 9 depicts the first parameter data set being alternately projected between a fourth convex set (912) and the second convex set (906). That is, the second instance (910) depicts the case where the threshold defining the first convex set (904) has been updated from the first threshold to the second threshold. In other words, to remove ambiguity, the convex set parameterized by the second threshold is referred to as the fourth convex set (912). Note that in the second instance (910), although the update from the first threshold to the second threshold changes the first convex set (904) to the fourth convex set (912), the second convex set (906) is left unchanged. This is because the second convex set (906) is parameterized by the first subset of the first parameter data set and is not affected by a change in the threshold value. In the second instance (910) the first parameter data set initially resides at the location of the first intersection (909) and, through alternating projection between the fourth convex set (912) and the second convex set (906) converges to the second intersection (913).

FIG. 9 depicts a third instance (914) where the second parameter data set is alternately projected between the first convex set (904) and a third convex set (916). The first convex set (904) is parameterized by the first threshold and is therefore unchanged from the first instance (902). The third convex set (916) is parameterized by the first subset of the second parameter data set and is analogous to convex set 222. The second parameter data set, with a first subset determined with a conventional method and a zero-valued second subset is initially located at the second point (917). Again, the use of points and 2D shapes to represent the space of the second parameter data set and associated convex sets is provided for illustrative purposes only. As seen in the third instance (914), the second point (917) is located within the third convex set (916) but not the first convex set (904). The directed arrows indicate projections to the convex sets. As seen in the third instance (914), the second point (917) is alternately projected between the first convex set (904) and the third convex set (916) until the second parameter data set converges at a third intersection (919).

The fourth instance (918) of FIG. 9 depicts the second parameter data set being alternately projected between the fourth convex set (912) and the third convex set (916). That is, the fourth instance (918) depicts the case where the threshold defining the first convex set (904) has been updated from the first threshold to the second threshold. In other words, to remove ambiguity, the convex set parameterized by the second threshold is referred to as the fourth convex set (912). Note that in the fourth instance (918), although the update from the first threshold to the second threshold changes the first convex set (904) to the fourth convex set (912), the third convex set (916) is left unchanged. This is because the third convex set (916) is parameterized by the first subset of the second parameter data set and is not affected by a change in the threshold value. In the fourth instance (918) the second parameter data set initially resides at the location of the third intersection (919) and, through alternating projections between the fourth convex set (912) and the third convex set (916) converges to the fourth intersection (921).

FIG. 9 can be readily expanded to depict instances involving a third parameter data set, a fourth parameter data set, and so on and so forth for all generated parameter data sets (Block 512 of FIG. 5). Likewise, FIG. 9 can be readily expanded to depict instances with more than two thresholds to include a third threshold, etc. While the 2D shapes of FIG. 9 are abstractions of the convex sets of the vector space of a given parameter data set, the shapes nonetheless indicate similarities between instances.

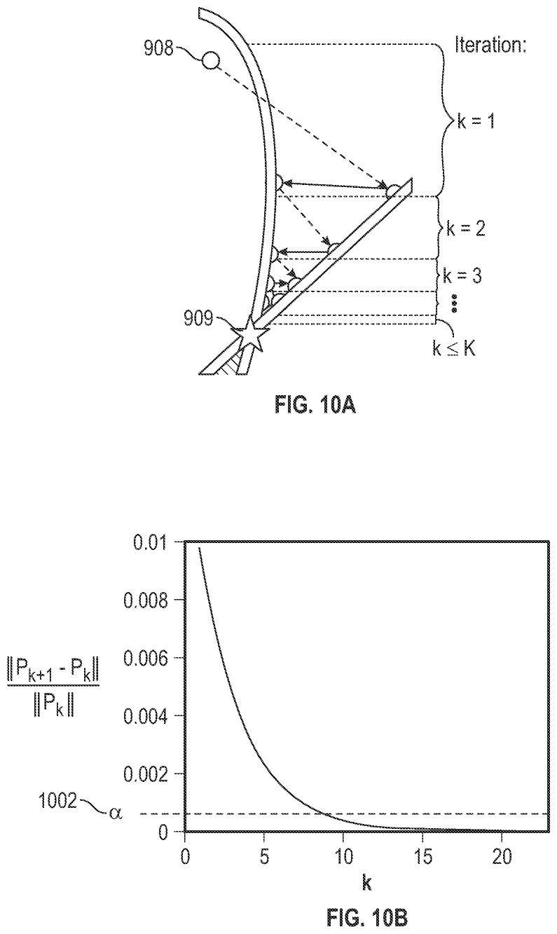

The purpose of FIG. 9 is to illustrate the CP method applied to multiple parameter data sets and across multiple outer loops (i.e., threshold updates). For any instance of FIG. 9, the directed arrows represent projections to a convex set. Thus, for any instance of FIG. 9, these arrows are intended to represent the inner loop of the CP method where a given parameter data set is alternately projected until a convergence criterion is satisfied. The first instance (902) of FIG. 9 has a callout box (930). The callout box (930) is expanded in FIG. 10A to illustrate the alternating projections of the inner loop of the CP method in greater detail. A seen in FIG. 10A, the inner loop iteration counter, k, is incremented for each pair of projections (i.e., projection to Ω₁, projection to Ω₂). The inner loop is terminated upon satisfaction of the termination criterion of EQ. 7. FIG. 10B depicts the convergence history for FIG. 10A. An example convergence threshold, α, (1002) is shown in FIG. 10B. In this example, the example convergence threshold (1002) is set to a value of 0.0005 and the convergence criterion would be satisfied with approximately 9 iterations of the inner loop assuming that K>9.

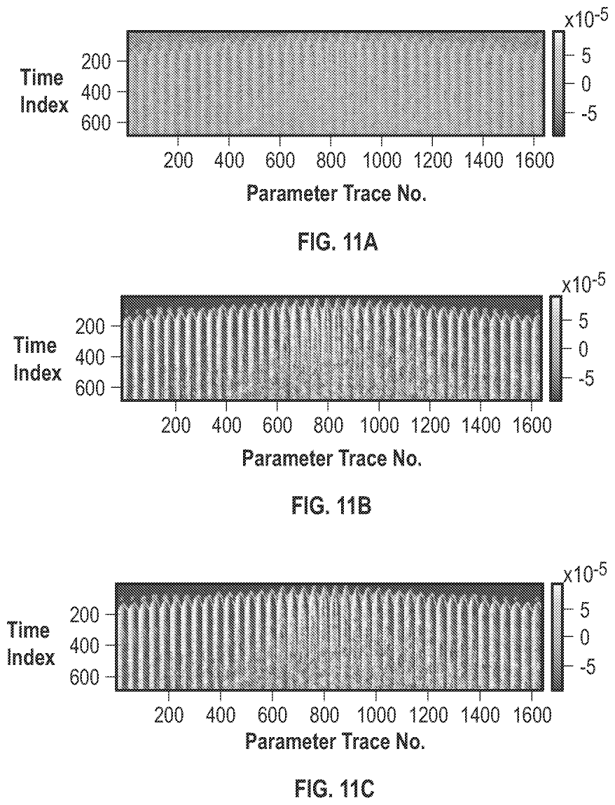

As a concrete example, FIGS. 11A-11c depict how an example parameter data set is altered with the CP method of FIG. 8. FIG. 11A depicts the values for an initially generated example parameter data set (e.g., Parameter A), where the example parameter data set was generated using a value of 30 for R. As seen in FIG. 11A, 30% of the values of the example parameter data set have been determined using a conventional method. These values are associated with sub-regions in the first subset. The remaining 70% of values in the example parameter data set are zero and are said to be in the second subset. The distribution of sub-regions in the first subset and in the second subset is random. In this example, the CP method is implemented on the example parameter data set with a threshold sequence composed of N threshold values and a max inner loop iterations threshold K=∞. FIG. 11B depicts the values of the example parameter data set after N/2 outer loop iterations. As seen in FIG. 11B, the values of the example parameter data set in the second subset are no longer zero demonstrating that these values are being determined. FIG. 11C depicts the example parameter data set after completion of the CP method. In FIG. 11C, all of the values in the example parameter data have been determined such that the example parameter data set may be used with a NLBF procedure to enhance the associated seismic data set (200).

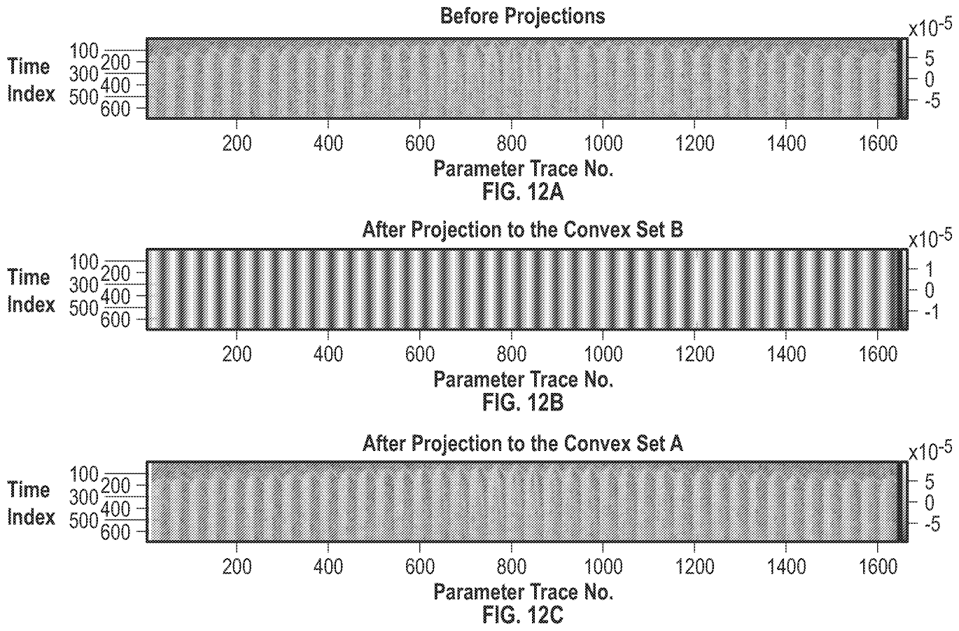

FIGS. 12A-12C depict the example parameter data set through the first two projections. In other words, FIGS. 12A-12C shown the example parameter data set throughout one iteration of the inner loop of FIG. 8. FIG. 12A depicts the example parameter data set before any projections. At this point, the example parameter dataset is zero-valued for 70% of the values (i.e., second subset). FIG. 12B depicts the results of applying a 2D Fourier transform to the example parameter data set, projecting it to the convex set 221, and applying an inverse 2D Fourier transform to be returned to the data domain. FIG. 12C depicts the result of projecting FIG. 12B to the convex set 22.

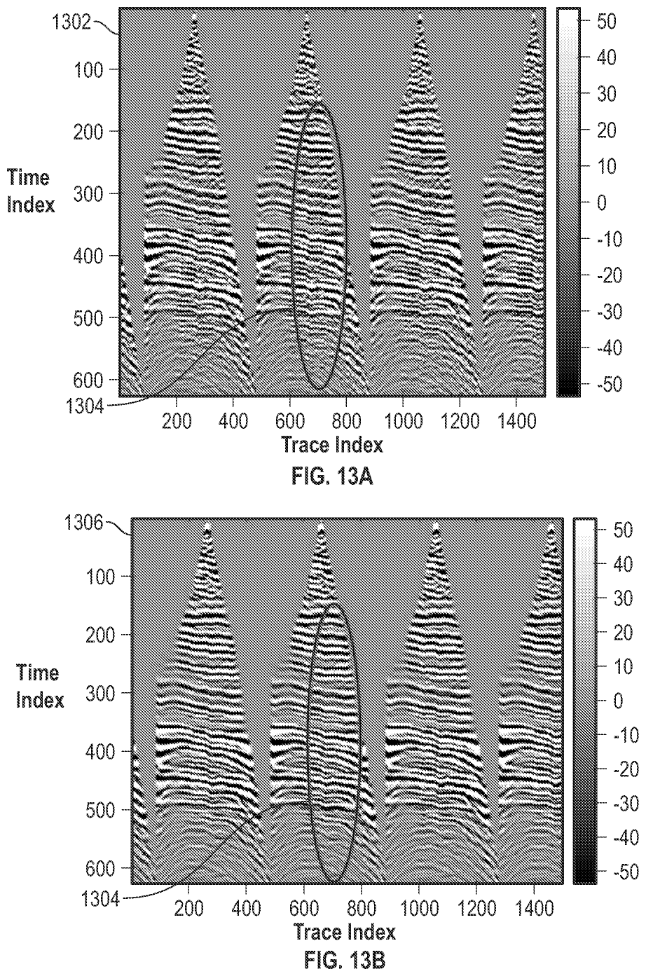

FIG. 13A depicts an example seismic data set (1302) before application of an NLBF procedure. FIG. 13B is annotated with an oval indicating a zone (1302) where scattering noise is present. Following the procedures of FIG. 8. NLBF parameters were determined using the CP method for the example seismic data set (1302). FIG. 13B depicts an example enhanced seismic data set (1306) after application of the NLBF procedure. As seen in FIG. 13B, scattering noise has been suppressed in the zone (1302).

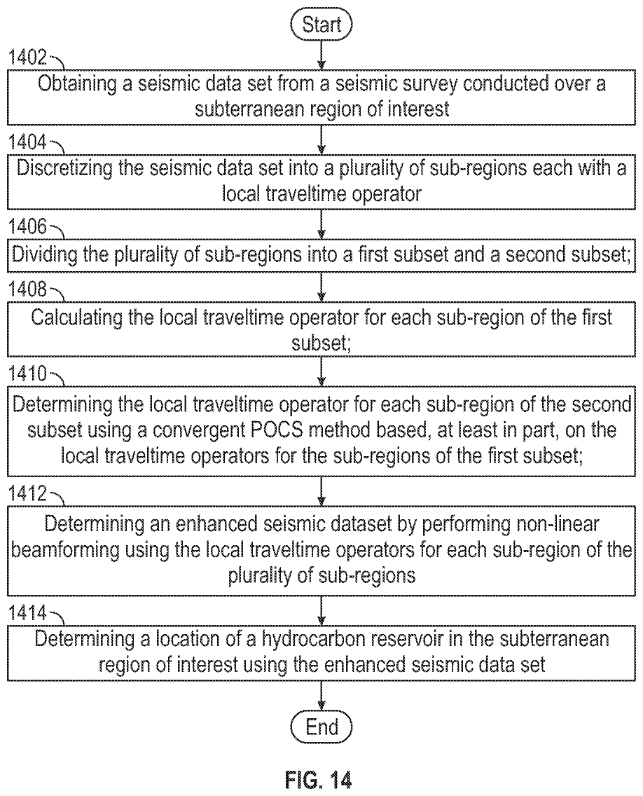

FIG. 14 depicts a flow chart outlining the process of applying NLBF to a seismic data set where move-out function parameters used in the NLBF procedure are determined using the CP method described herein, in accordance with one or more embodiments. In Block 1402 a seismic data set (200) is obtained from a seismic survey (100) conducted over a subterranean region of interest (102). In Block 1404, the seismic data set (200) is discretized into a plurality of sub-regions where each sub-region includes a move-out function parameterized by one or more parameters. To simplify the discussion, a move-out function with its associated parameters is referred to as a traveltime operator. That is, there is a traveltime operator for each sub-region. To further emphasize that there is a traveltime operator for each sub-region, the traveltime operators are referred to as local traveltime operators. Thus, the term traveltime operator may be used for any selected move-out function regardless off the number of parameters required by the move-out function. For example, the move-out function may be according to EQ. 1 such that the traveltime operator includes five parameters. In Block 1406, the plurality of sub-regions is divided into a first subset and a second subset. In one or more embodiments, sub-regions are randomly assigned to either the first subset or the second subset and the expected percentage of sub-regions in the first subset is given by R. In Block 1408, the local traveltime operator for each sub-region in the first subset is calculated. That is, the parameters of the move-out functions for each sub-region in the first subset are determined. In accordance with one or more embodiments, the local traveltime operator for each sub-region in the first subset is calculated using a conventional method (e.g., 5D brute force method). In Block 1410, the local traveltime operator for each sub-region of the second subset is determined using the convergent POCS (CP) method described herein. To determine the local traveltime operators of the second subset, the CP method is applied individually to each parameter of the move-out function using the local traveltime operators for the sub-regions of the first subset. In greater detail, a parameter data set is generated for each parameter of the selected move-out function and each parameter data set is initialized with zero values for the second subset and the determined values for the first subset (first subset parameter values determined in Block 1408). The CP method is applied to each of the one or more parameter data sets to determine the parameter values for the second subset. With all the parameter values determined for each parameter data set (for both the first subset and the second subset), the local traveltime operators for every sub-region in the plurality of sub-regions are known. In Block 1412, the seismic data set (200) is enhanced using non-linear beamforming (NLBF). The NLBF procedure is informed by the local traveltime operator of each sub-region in the plurality of sub-regions. In Block 1414, the location of a hydrocarbon reservoir (104) in the subterranean region of interest (102) is determined using the enhanced seismic data set.

Embodiments of the present disclosure may provide at least one of the following advantages. It is well known that calculating the one or more parameters of the move-out functions for each sub-region of a discretized seismic data set is the most computationally expensive step a NLBF procedure. This is because, traditionally, for each sub-region the one or more move-out function parameters are determined using a non-linear solver to optimize an objective function (i.e., conventional method). Embodiments disclosed herein significantly reduce the number of sub-regions where a conventional method is required to determine the one or more move-out function parameters of the sub-region. This is done by forming parameter data sets (one for each of the one or more parameters of the move-out functions) and determining the parameter values for many sub-regions using the CP method described herein. The CP method acts to reconstruct parameter data sets to determine the values of undetermined parameters. Embodiments disclosed herein improve computational efficiency by significantly reducing the number of sub-regions wherein the one or more parameters are determined using a conventional method. Further, embodiments disclosed herein operate directly on the model space of the move-out functions. That is, embodiments disclosed herein determine the values of parameters directly using their associated parameter data set.

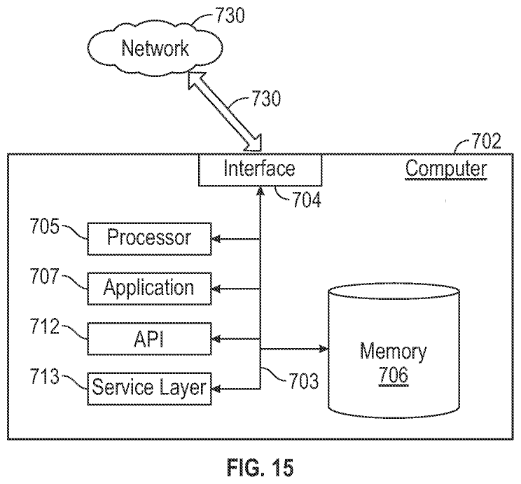

FIG. 15 further depicts a block diagram of a computer system (1502) used to provide computational functionalities associated with the methods, functions, processes, flows, and procedures as described in this disclosure, according to one or more embodiments. The illustrated computer (1502) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1502) may include a computer that includes an input device, such as a keypad, keyboard, touch screen, or other device that can accept user information, and an output device that conveys information associated with the operation of the computer (1502), including digital data, visual, or audio information (or a combination of information), or a GUI.

The computer (1502) can serve in a role as a client, network component, a server, a database or other persistency, or any other component (or a combination of roles) of a computer system for performing the subject matter described in the instant disclosure. In some implementations, one or more components of the computer (1502) may be configured to operate within environments, including cloud-computing-based, local, global, or other environment (or a combination of environments).

At a high level, the computer (1502) is an electronic computing device operable to receive, transmit, process, store, or manage data and information associated with the described subject matter. According to some implementations, the computer (1502) may also include or be communicably coupled with an application server, e-mail server, web server, caching server, streaming data server, business intelligence (BI) server, or other server (or a combination of servers).

The computer (1502) can receive requests over network (1530) from a client application (for example, executing on another computer (1502) and responding to the received requests by processing the said requests in an appropriate software application. In addition, requests may also be sent to the computer (1502) from internal users (for example, from a command console or by other appropriate access method), external or third-parties, other automated applications, as well as any other appropriate entities, individuals, systems, or computers.

Each of the components of the computer (1502) can communicate using a system bus (1503). In some implementations, any or all of the components of the computer (1502), both hardware or software (or a combination of hardware and software), may interface with each other or the interface (1504) (or a combination of both) over the system bus (1503) using an application programming interface (API) (1512) or a service layer (1513) (or a combination of the API (1512) and service layer (1513). The API (1512) may include specifications for routines, data structures, and object classes. The API (1512) may be either computer-language independent or dependent and refer to a complete interface, a single function, or even a set of APIs. The service layer (1513) provides software services to the computer (1502) or other components (whether or not illustrated) that are communicably coupled to the computer (1502). The functionality of the computer (1502) may be accessible for all service consumers using this service layer. Software services, such as those provided by the service layer (1513), provide reusable, defined business functionalities through a defined interface. For example, the interface may be software written in JAVA, C++, or other suitable language providing data in extensible markup language (XML) format or another suitable format. While illustrated as an integrated component of the computer (1502), alternative implementations may illustrate the API (1512) or the service layer (1513) as stand-alone components in relation to other components of the computer (1502) or other components (whether or not illustrated) that are communicably coupled to the computer (1502). Moreover, any or all parts of the API (1512) or the service layer (1513) may be implemented as child or sub-modules of another software module, enterprise application, or hardware module without departing from the scope of this disclosure.

The computer (1502) includes an interface (1504). Although illustrated as a single interface (1504) in FIG. 15, two or more interfaces (1504) may be used according to particular needs, desires, or particular implementations of the computer (1502). The interface (1504) is used by the computer (1502) for communicating with other systems in a distributed environment that are connected to the network (1530). Generally, the interface (1504) includes logic encoded in software or hardware (or a combination of software and hardware) and operable to communicate with the network (1530). More specifically, the interface (1504) may include software supporting one or more communication protocols associated with communications such that the network (1530) or interface's hardware is operable to communicate physical signals within and outside of the illustrated computer (1502).

The computer (1502) includes at least one computer processor (1505). Although illustrated as a single computer processor (1505) in FIG. 15, two or more processors may be used according to particular needs, desires, or particular implementations of the computer (1502). Generally, the computer processor (1505) executes instructions and manipulates data to perform the operations of the computer (1502) and any algorithms, methods, functions, processes, flows, and procedures as described in the instant disclosure.

The computer (1502) also includes a memory (1506) that holds data for the computer (1502) or other components (or a combination of both) that can be connected to the network (1530). The memory may be a non-transitory computer readable medium. For example, memory (1506) can be a database storing data consistent with this disclosure. Although illustrated as a single memory (1506) in FIG. 15, two or more memories may be used according to particular needs, desires, or particular implementations of the computer (1502) and the described functionality. While memory (1506) is illustrated as an integral component of the computer (1502), in alternative implementations, memory (1506) can be external to the computer (1502).

The application (1507) is an algorithmic software engine providing functionality according to particular needs, desires, or particular implementations of the computer (1502), particularly with respect to functionality described in this disclosure. For example, application (1507) can serve as one or more components, modules, applications, etc. Further, although illustrated as a single application (1507), the application (1507) may be implemented as multiple applications (1507) on the computer (1502). In addition, although illustrated as integral to the computer (1502), in alternative implementations, the application (1507) can be external to the computer (1502).

There may be any number of computers (1502) associated with, or external to, a computer system containing computer (1502), wherein each computer (1502) communicates over network (1530). Further, the term “client,” “user,” and other appropriate terminology may be used interchangeably as appropriate without departing from the scope of this disclosure. Moreover, this disclosure contemplates that many users may use one computer (1502), or that one user may use multiple computers (1502).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining a seismic data set from a seismic survey conducted over a subterranean region of interest;
discretizing the seismic data set into a plurality of sub-regions each with a local traveltime operator;
dividing the plurality of sub-regions into a first subset and a second subset;
calculating the local traveltime operator for each sub-region of the first subset;
determining the local traveltime operator for each sub-region of the second subset using a convergent POCS method based, at least in part, on the local traveltime operators for the sub-regions of the first subset;
determining an enhanced seismic dataset by performing non-linear beamforming using the local traveltime operator for each sub-region of the plurality of sub-regions; and
determining a location of a hydrocarbon reservoir in the subterranean region of interest using the enhanced seismic data set.

2. The method of claim 1, further comprising planning a wellbore to penetrate the hydrocarbon reservoir based on the location, wherein the planned wellbore comprises a planned wellbore path.

3. The method of claim 2, further comprising drilling the wellbore guided by the planned wellbore path.

4. The method of claim 1, wherein a selected percentage of sub-regions in the plurality of sub-regions are divided into the first subset.

5. The method of claim 1, wherein the local traveltime operator of each sub-region of the first subset is calculated using a 5D brute force method.

6. The method of claim 1, further comprising selecting a move-out function parameterized by one or more parameters.

7. The method of claim 6, wherein the local traveltime operator of each sub-region in the plurality of sub-regions comprises an independent move-out function of the same mathematical form as the selected move-out function.

8. The method of claim 6, further comprising generating a parameter data set for each parameter of the one or more parameters, wherein each parameter data set comprises a value for the associated parameter for each sub-region in the plurality of sub-regions.

9. The method of claim 8, wherein when determining the local traveltime operator for each sub-region of the second subset, the convergent POCS method is applied to each parameter dataset.

10. A non-transitory computer-readable memory comprising computer-executable instructions stored thereon that, when executed on a processor, cause the processor to perform steps comprising:
obtaining a seismic data set from a seismic survey conducted over a subterranean region of interest;
discretizing the seismic data set into a plurality of sub-regions each with a local traveltime operator;
dividing the plurality of sub-regions into a first subset and a second subset;
calculating the local traveltime operator for each sub-region of the first subset;
determining the local traveltime operator for each sub-region of the second subset using a convergent POCS method based, at least in part, on the local traveltime operators for the sub-regions of the first subset;
determining an enhanced seismic dataset by performing non-linear beamforming using the local traveltime operator for each sub-region of the plurality of sub-regions; and
determining a location of a hydrocarbon reservoir in the subterranean region of interest using the enhanced seismic data set.

11. The non-transitory computer-readable memory of claim 10, wherein a selected percentage of sub-regions in the plurality of sub-regions are divided into the first subset.

12. The non-transitory computer-readable memory of claim 10, wherein the local traveltime operator of each sub-region of the first subset is calculated using a 5D brute force method.

13. The non-transitory computer-readable memory of claim 11, wherein the steps further comprise:
receiving a selected move-out function, wherein the selected move-out function is parameterized by one or more parameters.

14. The non-transitory computer-readable memory of claim 13, wherein the local traveltime operator of each sub-region in the plurality of sub-regions comprises an independent move-out function of the same mathematical form as the selected move-out function.

15. The non-transitory computer-readable memory of claim 13, wherein the steps further comprise:
generating a parameter data set for each parameter of the one or more parameters, wherein each parameter data set comprises a value for the associated parameter for each sub-region in the plurality of sub-regions.

16. The non-transitory computer-readable memory of claim 15, wherein when determining the local traveltime operator for each sub-region of the second subset, the convergent POCS method is applied to each parameter dataset.

17. The non-transitory computer-readable memory of claim 11, wherein the convergent POCS method comprises a convergence criterion.

18. A system, comprising:
a seismic acquisition system configured to perform a seismic survey over a subterranean region of interest and record a seismic data set; and
a computer processor configured to:
obtain the seismic data set from the seismic acquisition system;
discretize the seismic data set into a plurality of sub-regions each with a local traveltime operator;
divide the plurality of sub-regions into a first subset and a second subset;
calculate the local traveltime operator for each sub-region of the first subset;
determine the local traveltime operator for each sub-region of the second subset using a convergent POCS method based, at least in part, on the local traveltime operators for the sub-regions of the first subset;
determine an enhanced seismic dataset by performing non-linear beamforming using the local traveltime operator for each sub-region of the plurality of sub-regions; and
determine a location of a hydrocarbon reservoir in the subterranean region of interest using the enhanced seismic data set.

19. The system of claim 18, further comprising a wellbore planning system configured to plan a wellbore to penetrate the hydrocarbon reservoir based on the location, wherein the planned wellbore comprises a planned wellbore path.

20. The system of claim 19, further comprising a wellbore drilling system configured to drill a wellbore guided by the planned wellbore path.
